(19) United States
(12) Patent Application Publication
(10) Pub. No.: US 2011/0036315 A1
(43) Pub. Date: Feb. 17, 2011

(54) VALVE LIFT CONTROL APPARATUS

(75) Inventor: Ivan M. Lazich, Skokie, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company LLC, Warrenville, IL (US)

(21) Appl. No.: 12/540,116

(22) Filed: Aug. 12, 2009

(51) Int. Cl. F01L 9/02; F01L 1/34; F16K 31/00

(52) U.S. Cl. 123/90.12; 123/90.16; 251/62

(57) ABSTRACT

An actuator is provided for operating a valve in an engine. The actuator includes a casing forming an actuation chamber for holding a working fluid and having a first cylinder portion with a first opening and a second cylinder portion with a second opening. A first plunger is held slidably at least partially within the first cylinder portion and exposed through the first opening, and a second plunger is held slidably at least partially within the second cylinder portion and exposed through the second opening. The first plunger is reciprocally movable by action of a rotating cam to displace working fluid within the actuation chamber. The second plunger reciprocally movable by pressure exerted on the second plunger by the working fluid and arranged to exert force on a valve. The casing can also include a valve opening control comprising a third opening in the casing and a control piston slidably fit within the third opening to adjust the movement of the second plunger in reaction to movement of the first plunger, or for opening exhaust valves for engine braking.

### FIELD OF THE INVENTION

This invention relates generally to cylinder heads in internal combustion engines. More particularly, this invention relates to cylinder heads having mechanisms to open intake and exhaust valves.

### BACKGROUND OF THE INVENTION

Most internal combustion engines have actuated valves that selectively open and close to provide combustion air and remove exhaust gases from each cylinder. Internal combustion engines usually convert chemical energy from a petroleum-based fuel such as gasoline or diesel into mechanical energy. Diesel engines usually compress air in the cylinder and then inject fuel into the cylinder for the compressed air to ignite. The ignited fuel generates rapidly expanding gases that actuate a piston. Each piston usually is connected to a crankshaft or similar device for converting the reciprocating motion of the piston into rotational motion. The rotational motion from the crankshaft may be used to propel a vehicle, operate a pump or an electrical generator, or perform other work. The vehicle may be a truck, an automobile, a boat, or the like.

Many diesel engines have intake and exhaust valves near a fuel injector on the top of each cylinder. Each intake and exhaust valve usually has a valve element disposed in a passageway formed by a cylinder head. The passageway connects to the cylinder through an opening in a valve seat formed by the cylinder head. In intake valves, intake air flows through the intake passageway into the cylinder. In exhaust valves, exhaust gases flow out of the cylinder into the exhaust passageway. The valve element usually has a stem connected to a head. A spring typically is disposed on the stem. The spring biases the head into a closed position against the valve seat. Such a configuration is described for example in U.S. Pat. No. 7,347,172.

Diesel engines usually have an actuating mechanism connected to the stem of each valve. The actuating mechanism selectively presses against the stem, overcomes the biasing force of the spring, and thus moves the head into an open position away from the valve seat. The actuating mechanism may be a push rod, a rocker arm, a cam on a camshaft, a hydraulically actuated drive pin, a combination thereof, or the like.

Typically, the valves connect to rocker arms, which rotate on a pivot ball to open and close the valves. Typically, there is a separate rocker arm for each valve. Push rods operate the rocker arms and extend through the engine cylinder head to connect to a camshaft, via tappets. As the camshaft rotates, the push rods actuate the rocker arms to open and close the valves. The camshaft is designed to open and close the valves in conjunction with the cycling of the piston in the cylinder. Such a configuration is disclosed in U.S. Pat. No. 6,484,683. Some engines use a cam-in-head design which relocates the cam shaft up into the head and eliminates the push rods in favor of valve lifters that ride on cams along the cam shaft.

In addition to valve opening mechanisms which operate the intake and exhaust valves for normal engine operation, an additional selectively controlled exhaust valve opening mechanism can be incorporated into the engine to facilitate engine braking, particularly for turbocharged diesel engines. Such a system is described for example in U.S. Pat. No. 6,779,506.

### SUMMARY OF THE INVENTION

According to exemplary embodiments of the invention, an actuator is provided for operating a valve in an engine. The actuator includes a casing forming an actuation chamber for holding a working fluid and having a first cylinder portion with a first opening and a second cylinder portion with a second opening. A first plunger is held slidably at least partially within the first cylinder portion and exposed through the first opening, and a second plunger is held slidably at least partially within the second cylinder portion and exposed through the second opening. The first plunger is reciprocally movable by action of a rotating cam to displace working fluid within the actuation chamber. The second plunger reciprocally movable by pressure exerted on the second plunger by the working fluid and arranged to exert force on a valve.

According to an exemplary embodiment, the casing has an inverted U-shape with the first and second openings located within legs of the inverted U-shape.

The casing can also include a valve opening control comprising a third opening in the casing and a control piston slidably fit within the third opening. The control piston is operable by the control to selectively displace working fluid to adjust the movement of the second plunger in reaction to movement of the first plunger. This capability can allow for variable valve lift (opening) control to improve combustion, or to open exhaust valves for engine braking.

The valve opening control comprises a control operator, connected to the control piston and operable by the valve opening control to position the control piston within the third opening.

The exemplary embodiments for operating an engine valve provides:

a means for holding a working fluid;

a first plunger means movable into and out of the means for holding the working fluid;

a second plunger means movable into and out of the means for holding the working fluid, the second plunger means for exerting a force on a valve to open the valve; wherein

the first plunger means selectively movable into the means for holding the working fluid to exert pressure on the second plunger means to move the second plunger means out of the means for holding the working fluid.

The embodiments can also provide a third plunger means selectively movable into the means for holding the working fluid, the third plunger means for selectively displacing working fluid within the means for holding to adjust movement of the second plunger means.

The third plunger means can adjust the displacement of the second plunger means in response to the movement of the first plunger means.

The working fluid for the exemplary embodiments can be an oil or a gas, such as air.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 is a top perspective view of a prior art rocker carrier with rocker arm assemblies mounted thereon;

FIG. 2 is a schematic sectional view of a rocker device according to a first exemplary embodiment of the invention; and

FIG. 3 is a schematic sectional view of a rocker device according to a second exemplary embodiment of the invention.

### DESCRIPTION OF THE INVENTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

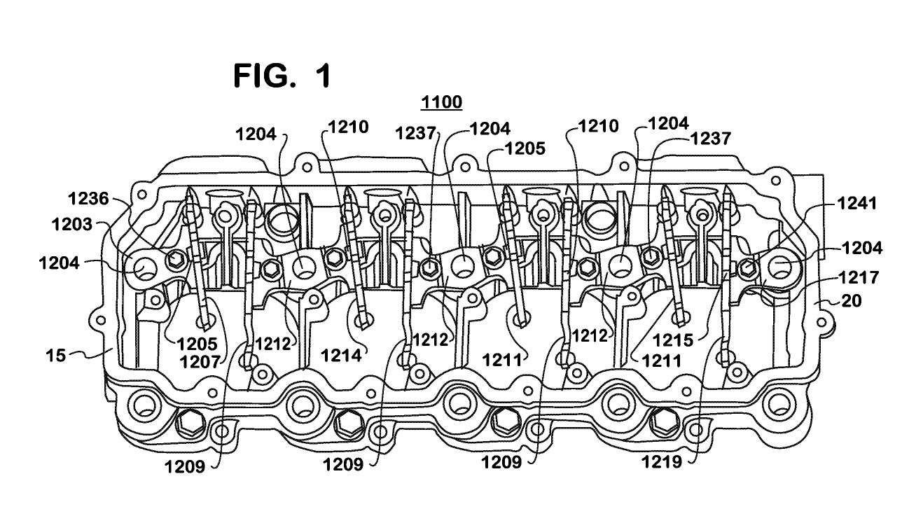

FIG. 1 shows a perspective view of a prior art rocker carrier 1100 as described more completely in U.S. Pat. No. 6,484,683, herein incorporated by reference. The rocker carrier 1100 is adapted to preferably be used on one side or bank of a V-8 type engine.

FIG. 1 shows a plurality of rocker arm assemblies 1205, 1210 and 1217 mounted on the rocker arm pedestals and attached by hold down bolts 1236, 1237 and 1241. The rocker arm assemblies 1205, 1210 and 1217 have rocker arms 1207, 1209, 1211, 1219 that will actuate valve bridges (not shown) when actuated by push rods (not shown) at appropriate times. FIG. 1 shows that two types of rocker arm assemblies 1205, 1210 and 1217 are preferably used with the rocker carrier 1100, though other appropriate configuration may be used as well.

There is shown three dual rocker arm assemblies 1210 which cooperatively support a dual fulcrum plate 1212. The dual fulcrum plates 1212 will each hold an intake and exhaust rocker arm 1209 and 1211. In a preferred embodiment, the intake and exhaust rocker arms 1209 and 1211 on the dual fulcrum plates 1212 will operate valves on different engine cylinders. During intake, when the dual rocker arm assemblies 1210 operate, the intake rocker arms 1211 will appropriately actuate corresponding intake valves (not shown) via an intake valve bridge (not shown). During exhaust, when the dual rocker arm assemblies 1210 operate, the exhaust rocker arms 1209 will appropriately actuate corresponding exhaust valves (not shown) via an exhaust valve bridge (not shown).

There is also shown a first and second end rocker arm assembly 1205 and 1215 in the rocker carrier 1100 which are adjacent to the first 15 and second 20 end walls which have a first and second end fulcrum plate 1203 and 1217. The first end fulcrum plate 1203 will preferably hold an intake rocker arm 1207. During intake, when the first end rocker arm assembly 1205 operates, the intake rocker arm 1207 will appropriately actuate corresponding intake valves (not shown) via an intake valve bridge (not shown). The second end fulcrum plate 1217 will preferably hold an exhaust rocker arm 1219. During exhaust, when second end rocker arm assembly 1215 operates, the exhaust rocker arm 1219 will appropriately actuate corresponding exhaust valves (not shown) via an exhaust valve bridge (not shown).

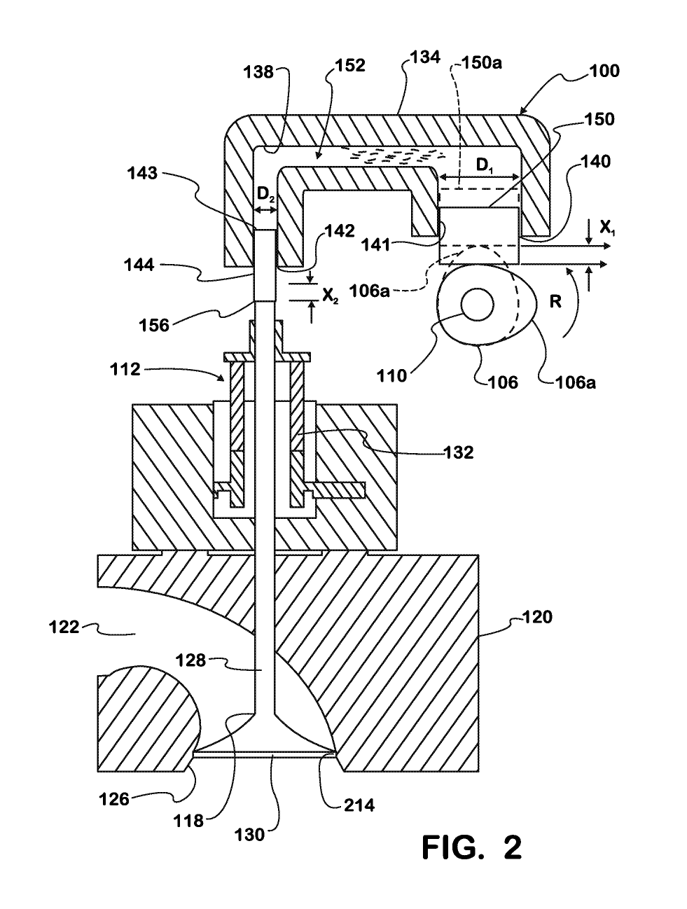

FIG. 2 illustrates a first exemplary embodiment valve actuation system 100 of the invention for use within an engine. The valve actuation system would replace the rocker arm assemblies shown in FIG. 1. According to this embodiment, a cam 106 formed on a camshaft 110 is driven in rotation in the direction “R” by a crankshaft (not shown) of the engine. The camshaft is driven in a known way by a chain or belt or gears. Spaced from the cam 106 is a valve assembly 112.

Although only one cam 106 and one valve actuation system 100 is shown, it should be understood that in practice plural cams 106 would be formed on the camshaft 110 and the cams would operate plural valve actuation systems 100, one for each valve, both intake and exhaust.

The valve assembly 112 includes a valve element 118 disposed in a cylinder head 120 of the engine. The valve assembly 112 may be an intake valve, an exhaust valve, or the like. The cylinder head 120 forms a passageway 122 that extends to a cylinder through a valve opening 124 defined by a valve seat 126. The valve element 118 includes a valve stem 128 connected to a valve head 130. A biasing device 132 is disposed on the valve stem 128. The biasing device 132 applies a biasing force to hold the valve head 130 against the valve seat 126—a closed position. The biasing device 132 may be a hydraulic spring, a mechanical spring, or the like.

The actuation system 100 may include a casing 134 that is fixedly mounted to the cylinder head 120. The casing 134 has a confined internal passage 138 having a first opening 140 into a first cylinder portion 141 and having a first inside diameter “D₁” and a second opening 142 into a second cylinder portion 143 and having a second inside diameter “D₂.” A first plunger or lifter 150 is sealingly fit within the cylinder portion 141 and rides on the cam 106 either directly as shown or by way of an interposed push rod (not shown) between the lifter 150 and the cam 106. When a lobe 106a of the cam extends upward, the lifter is driven upward into the cylinder portion 141. A second plunger or pin 144 is sealingly disposed in internal passage 138, within the cylinder portion 143. The pin 144 engages the valve stem 128 outside of the cylinder portion 143. The engagement can be a connection or merely an abutment or contact at an interface 156.

To open the valve assembly 112, the cam rotates and the lobe 106a drives the lifter 150 into the cylinder 141, shown in dotted line as an upward position 150a, by a distance X₁. The passage 138 is filled with a substantially non-compressible working fluid 152, such as engine oil, another hydraulic fluid, or the like. It is also possible that the working fluid is a gas, such as pressurized air. A pressure is generated within the working fluid by upward movement of the lifter 150 and the resistance of the biasing device 132. The pressure is sufficient to drive the pin 144 down, by a distance X₂ to press the valve stem 128 down, overcoming the force of the biasing device 132, to move the valve head 130 off of (below) the seat 126.

To close the valve, after the lobe 106a rotates beyond the lifter 150, the lifter is lowered and the pin 144 is forced upward by force from the biasing device 132 via the valve stem.

The relationship of movement of the pin 144 with the movement of the piston 256 and the lifter 150 can be expressed as follows:

X₂=(Dᵢ/D₂)²X₁
where X₂ is the distance the pin travels, and
X₁ is the distance the lifter travels.
   If the pin 144 has a smaller diameter than the lifter, the pin will travel a greater distance for a given distance of movement of the lifter.

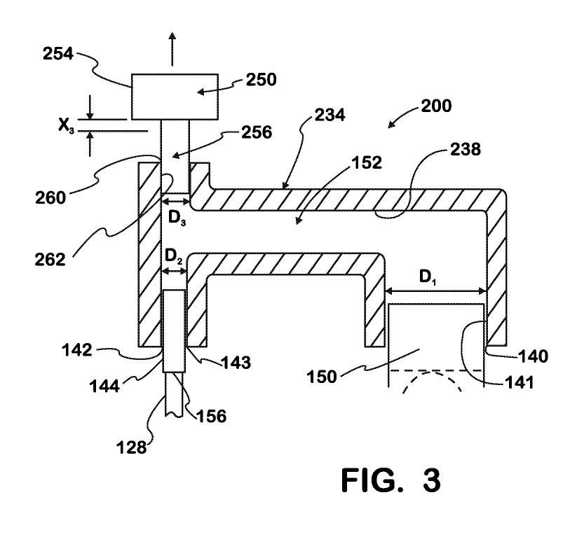

FIG. 3 illustrates a second exemplary embodiment of the invention, a valve actuation device 200. Items that are identically numbered as in the first embodiment are configured substantially the same. The device 200 may include a casing 234 that is fixedly mounted to the cylinder head 120. The casing 234 has a confined internal passage 238 having the first opening 140 into the first cylinder portion 141 and having the first inside diameter “D₁” and the second opening 142 into the second cylinder portion 143 and having the second inside diameter “D₂.” When a lobe 106a of the cam extends upward, the lifter is driven upward into the cylinder 141. The pin 144 engages the valve stem 128 outside of the cylinder portion 143.

To open the valve assembly 112, the cam rotates and the lobe 106a drives the lifter 150 into the cylinder 141, shown in dotted line as the upward position 150a, by the distance X₁, which is the maximum stroke. The passage 238 is filled with the substantially non-compressible working fluid 152, such as engine oil, another hydraulic fluid, or the like. A pressure is generated within the working fluid by upward movement of the lifter 150 and the resistance of the biasing device 132. The pressure is sufficient to drive the pin 144 down a distance X₂ to press the valve stem 128 down, overcoming the force of the biasing device 132, to move the valve head 130 off of the seat 126.

To close the valve, after the lobe 106a rotates beyond the lifter 150, the lifter is lowered and the pin 144 is forced upward by force from the biasing device 132 via the valve stem.

The second embodiment also includes a valve opening control 250. The control includes an operator 254 that interacts with a displacement control plunger or piston 256. The operator 254 can be connected to the piston 256 or merely abut or contact the piston. The operator can be moved or allowed to move by an electro-mechanical actuator or by selectably pressurized hydraulic fluid, such as described in U.S. Pat. No. 6,779,506, herein incorporated by reference. Alternatively, the operator can be controlled in movement by other pneumatic or electric motors or actuators.

The displacement control piston 256 is sealingly and slidingly fit into a hole 260 and into a third cylinder portion 262 of the casing 234 that has an inside diameter “D₃.” The displacement control piston can be used to increase or lessen the displacement X₂ of the pin 144 given a displacement X₁ of the lifter and thus the amount of opening of the valve, according to the amount of movement X₃ of the displacement control piston 256 within the third cylinder portion 262. This controlled movement of the valve head caused by the movement of the control piston 256 is independent of, but adds to, or subtracts from, the controlled movement of the valve head controlled by movement of the lifter 150 alone.

According to one mode of operation, the operator can be set in a default position. If the operator 254 allows the piston 256 to move up a preselected or controlled gap or amount, the distance X₃, when the cam forces the lifter 150 upward by the distance X₁, the resultant movement X₂ of the pin 144 is reduced. If the operator 254 moves the piston 256 downward a preselected or controlled amount X₃, when the cam forces the lifter 150 upward by the distance X₁, the resultant movement X₂ of the pin 144 is increased. This control using can be undertaken to improve combustion during certain operating modes

According to another mode of operation, the operator 254 can move the control piston 256 inward (downward), the distance X₃, to drive the pin 144 down to press the valve stem 128 down, overcoming the force of the biasing device 132, to move the valve head 130 off of the seat 126.

According to this mode, the control 250 can be used to facilitate engine braking. Engine braking is described more completely in U.S. Pat. No. 6,779,506, herein incorporated by reference. The engine brake system takes advantage of the individual exhaust valve assemblies 112 at individual cylinders. By operating an internal mechanism of a turbocharger, such as turbocharger vanes, to create a certain restriction on the flow through the exhaust system, and at the same time, forcing exhaust valve assemblies 112 to be open to some extent, the kinetic energy of the moving motor vehicle operates the engine like a pump that forces contents of the engine cylinders through the created restriction. Such forced dissipation of the kinetic energy of the vehicle slows the vehicle.

Each exhaust valve assembly 112 is forced open by a respective operator 254 of the engine brake system moving downward according to FIG. 3. When the exhaust valves are not being forced open by operators 254, they operate at proper times during the engine cycle to allow products of combustion to exit cylinders and pass into exhaust system.

The relationship of movement of the pin 144 with the movement of the piston 256 and the lifter 150 can be expressed as follows:

X₂=(Dᵢ/D₂)²X₁−(D₃/D₂)²X₃
where X₂ is the distance the pin travels,
X₁ is the distance the lifter travels, and
X₃ is the distance the piston travels.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. An actuator for operating a valve in an engine, comprising:
a casing forming an actuation chamber for holding a working fluid and having a first cylinder portion with a first opening and a second cylinder portion with a second opening, a first plunger held slidably at least partially within the first cylinder portion and exposed through the first opening, and a second plunger held slidably at least partially within the second cylinder portion and exposed through the second opening, the first plunger reciprocally movable by action of a rotating cam to displace working fluid within the actuation chamber, the second plunger reciprocally movable by pressure exerted on the second plunger by the working fluid and arranged to exert force on a valve.

2. The actuator of claim 1, wherein the casing includes a valve opening control comprising a third opening in the casing and a control piston slidably fit within the third opening, the control piston operable by the control to selectively displace working fluid to adjust the movement of the second plunger in reaction to movement of the first plunger.

3. The actuator of claim 2, wherein the control comprises a control operator, connected to the control piston and operable by the control to position the control piston within the third opening.

4. The actuator of claim 2, wherein the casing has an inverted U-shape with the first and second openings located within legs of the inverted U-shape.

5. The actuator of claim 1, wherein the casing has an inverted U-shape with the first and second openings located within legs of the inverted U-shape.

6. An actuator for operating a valve in an engine, comprising:
a means for holding a working fluid;
a first plunger means movable into and out of the means for holding the working fluid;
a second plunger means movable into and out of the means for holding the working fluid, the second plunger means for exerting a force on a valve to open the valve;
the first plunger means selectively movable into the means for holding the working fluid to exert pressure on the second plunger means to move the second plunger means out of the means for holding the working fluid.

7. The actuator of claim 6, comprising a third plunger means selectively movable into the means for holding the working fluid, the third plunger means for selectively displacing working fluid within the means for holding to adjust movement of the second plunger means.

8. The actuator of claim 7, wherein the third plunger means adjust the displacement of the second plunger means in response to the movement of the first plunger means.

9. The actuator of claim 6, wherein the working fluid is an oil.

10. The actuator of claim 6, wherein the working fluid is a gas.

11. In an engine having an engine block having reciprocatble pistons within cylinders, the pistons connected to a crankshaft for converting reciprocating movement of the pistons to rotary power, a head above the cylinders holding a movable an intake valve for allowing air into each cylinder and a movable exhaust valve for allowing exhaust gas out of each cylinder, an actuator for opening at least one of the exhaust valves or the intake valves, comprising:
a casing forming an actuation chamber for holding a working fluid and having a first cylinder portion with a first opening and a second cylinder portion with a second opening, a first plunger held slidably at least partially within the first cylinder portion and exposed through the first opening, and a second plunger held slidably at least partially within the second cylinder portion and exposed through the second opening, the first plunger reciprocally movable by action of a rotating cam to displace working fluid within the actuation chamber, the second plunger reciprocally movable by pressure exerted on the second plunger by the working fluid and arranged to exert force on a valve.

12. The actuator of claim 11, wherein the casing includes a valve opening control comprising a third opening in the casing and a control piston slidably fit within the third opening, the control piston operable by the control to selectively displace working fluid to adjust the movement of the reaction portion in reaction to movement of the actuation portion.

13. The actuator of claim 12, wherein the control comprises a control operator, connected to the control piston and operable by the control to position the control piston within the third opening.

14. The actuator of claim 12, wherein the casing has an inverted U-shape with the first and second openings located within legs of the inverted U-shape.

15. The actuator of claim 11, wherein the casing has an inverted U-shape with the first and second openings located within legs of the inverted U-shape.

16. The actuator according to claim 11 wherein the working fluid is an oil.
